(19) United States
(12) Patent Application Publication
(10) Pub. No.: US 2026/0236990 A1
(43) Pub. Date: Aug. 13, 2026

(54) Cryptocurrency Trading System

(71) Applicant: Adam Denoto, Brook Park, OH (US)

(72) Inventor: Adam Denoto, Brook Park, OH (US)

(21) Appl. No.: 19/293,123

(22) Filed: Aug. 7, 2025

Related U.S. Application Data
(60) Provisional application No. 63/756,322, filed on Feb. 10, 2025.

(51) Int. Cl. G06Q 40/04; G06Q 20/06

(52) U.S. Cl. CPC G06Q 40/0421; G06Q 20/065; G06Q 2220/00

(57) ABSTRACT

A decentralized cryptocurrency trading vault system that enables automated crypto investment and profit generation outside of traditional banking systems. The system includes a mobile application operable on a user device, providing user interfaces for account creation, paycheck deposit, risk profile selection, portfolio monitoring, and trade notifications. The mobile application communicates with a backend server via a secure network. The server comprises an artificial intelligence (AI) trading engine configured to execute trades based on user-defined investment risk preferences and real-time market data, a sentiment analyzer to interpret external market signals, and an API manager to facilitate communication with external crypto exchanges and banks. A secure or electronic vault stores user funds in segregated accounts, preserving capital while enabling continuous trading.

### CROSS REFERENCE TO RELATED APPLICATION

The present application claims priority to, and the benefit of, U.S. Provisional Application No. 63/756,322 which was filed on Feb. 10, 2025 and is incorporated herein by reference in its entirety.

### FIELD OF THE INVENTION

The present invention generally relates to decentralized financial platforms and cryptocurrency trading systems. More specifically, the present invention relates to an AI-powered cryptocurrency trading vault configured to autonomously execute crypto asset trades based on user-defined preferences and real-time market conditions. The invention comprises a mobile application operable on a user device and a backend server including an artificial intelligence trading engine, sentiment analyzer, and application programing interface (API) integration module. The system is configured to receive user deposits, convert fiat currency to cryptocurrency, and perform continuous automated trades while preserving the principal amount in a secure digital vault. The AI engine dynamically adjusts strategies based on historical data, technical indicators, and external market sentiment. Accordingly, the present disclosure makes specific reference thereto. Nonetheless, it is to be appreciated that aspects of the present invention are also equally applicable to other like applications, devices, and methods of manufacture.

### BACKGROUND

By way of background, conventional banking systems are based on fractional reserve practices, wherein financial institutions lend out a substantial majority, more than 90% of the total capital deposited by customers. While the conventional banking systems are designed to stimulate economic activity and credit access, the systems impose financial disadvantages on individual account holders.

In the conventional banking systems, users'deposits are not directly invested on their behalf. Instead, the banks generate profit through interest-bearing loans, while depositors often receive minimal interest in return. Furthermore, in the event that a large number of account holders simultaneously request withdrawals, banks may lack sufficient liquidity to meet these demands, potentially resulting in catastrophic bank failures.

Furthermore, most individuals live paycheck to paycheck while financial institutions profit off of their idle capital. Depositors are often excluded from high-yield opportunities and exposed to systemic risk without direct benefit. As a result, wealth accumulation remains inaccessible to the majority of consumers, thereby widening the financial inequality gap. In contrast, emerging technologies such as artificial intelligence (AI), blockchain, and decentralized finance (DeFi) introduce opportunities for redefining capital utilization and wealth generation. Accordingly, individuals desire a decentralized banking model that enables users to directly benefit from continuous investment of their own deposits.

Therefore, there exists a long-felt need in the art for a decentralized financial system that enables users to grow wealth without relying on traditional banks. There is a long-felt need for a platform that enables users to deposit money, such as from their paychecks, and have that capital securely traded on their behalf. Further, there is a need in the art for a decentralized trading vault that integrates artificial intelligence (AI) to execute trades based on market conditions and user preferences. Additionally, there is a need for a user-centric system that provides transparency through a mobile application interface, enabling users to track profits, customize risk levels, and receive real-time trade notifications. Finally, there is a need for a platform that provides consistent daily profit generation, secure or electronic vault storage, and fully autonomous financial participation outside centralized banking infrastructures.

The subject matter disclosed and claimed herein, in one embodiment, comprises a decentralized cryptocurrency trading vault platform that uses AI-driven automation to enable users to securely invest and grow capital. The platform includes a mobile application operable on a user device such as a smartphone or tablet. The mobile application provides an interactive dashboard for creating accounts, depositing paychecks, selecting investment risk profiles, and monitoring trading performance. The application is communicatively coupled to a backend trading server via a secure network. The backend server includes an AI trading engine that builds and executes personalized trading strategies based on user preferences and market conditions, along with a sentiment analyzer that evaluates external financial signals to refine predictions. A secure or electronic vault stores user principal deposits and isolates them from market risk, while profits generated by the trading engine are returned to the user's designated savings pool.

In one embodiment, the AI trading engine uses machine learning (ML) algorithms trained on real-time and historical trading data to optimize crypto trade execution. The sentiment analyzer gathers and interprets financial news, social media activity, blockchain events, and technical indicators to generate sentiment signals. These signals are fed into the AI engine to dynamically adjust trading strategies. The server includes an API manager that facilitates communication with third-party crypto exchanges and external bank accounts. Trade is executed automatically without requiring manual input.

In this manner, the decentralized cryptocurrency trading vault platform of the present invention addresses the limitations of traditional banking and investment methods by enabling wealth generation through secure, automated crypto trading. The system protects users from capital erosion, eliminates reliance on loans and centralized lending, and ensures that investment returns are maximized through intelligent automation. The system uses AI for decision-making and sentiment analysis, and provides mobile interfaces, thereby offering a transparent, profitable, and secure alternative to conventional savings systems.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a decentralized cryptocurrency trading vault system. The system comprises a mobile application operable on a user device, the mobile application comprises a plurality of user interfaces to enable a user to scan and deposit a paycheck, select an investment risk profile, monitor portfolio performance, and receive trading and profit notifications. A server is communicatively coupled to the mobile application via a network, the server comprises an artificial intelligence (AI) trading engine configured to execute cryptocurrency trades based on the user's selected investment risk profile and using real-time and historical trading data, a sentiment analyzer is configured to analyze market sentiment from external data sources and provide sentiment signals to the AI trading engine, an API manager is configured to communicate with one or more external crypto exchanges and third-party banks, a user database stores user data including login credentials, trading history, deposit records, and risk preferences, and a secure or electronic vault is configured to store user funds, prevent unauthorized access, and segregate user principal capital from trading profits.

In another embodiment, a method for automated cryptocurrency trading via a decentralized trading platform is disclosed. The method includes receiving a paycheck from a user and depositing funds into a secure savings vault, converting the deposited funds from fiat currency to cryptocurrency using one or more external exchange rates, and executing cryptocurrency trades using an artificial intelligence trading engine, the trades being based on the user's selected investment risk profile and real-time market conditions.

In one embodiment, a mobile application for decentralized cryptocurrency investment is disclosed. The mobile application for decentralized cryptocurrency investment comprises a dashboard module configured to display portfolio performance, historical profits and losses, total crypto holdings, and enable adjustments to investment preferences, a notifications module is configured to display real-time alerts relating to trade execution, deposit confirmations, and market volatility, a risk profile interface is configured to enable a user to select one of a plurality of predefined risk levels, a paycheck deposit interface is configured to scan or upload a paycheck image for processing and transfer of funds into a secure trading vault, and a communication interface configured to securely transmit user data and receive system updates from a remote trading server over an encrypted network.

In yet another embodiment, an artificial intelligence-based trading engine for use in a decentralized cryptocurrency trading system is disclosed. The trading engine is configured to train on historical and real-time cryptocurrency trading data, build personalized trading strategies for each user based on a selected investment risk profile and trading preferences stored in a user database, place cryptocurrency trades, and analyze trade results and reinvest profits into future trading cycles or transfer to a user-designated savings pool.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a system architecture diagram of decentralized cryptocurrency trading vault platform of the present invention in accordance with the disclosed structure;

FIG. 2 illustrates a component-level diagram showing the modules included in the mobile application used in the decentralized cryptocurrency trading vault platform of the present invention in accordance with the disclosed structure;

FIG. 3 illustrates an exemplary risk profile user interface displayed by the mobile application in accordance with one embodiment of the present invention;

FIG. 4 illustrates a graphical user interface for a paycheck deposit for enabling users to initiate fiat funding of their trading account in accordance with the disclosed architecture;

FIG. 5 illustrates a notification graphical user interface of the mobile application that enables users to receive real-time alerts and system-generated messages in accordance with one embodiment of the present invention;

FIG. 6 illustrates a flowchart depicting an exemplary process flow for automating cryptocurrency trading and profit realization using the decentralized cryptocurrency trading vault platform of the present invention;

FIG. 7 illustrates a flowchart depicting a detailed sub-process of fiat-to-crypto conversion in the decentralized trading system of the present invention; and

FIG. 8 illustrates a flowchart illustrating an exemplary emergency trading control process implemented by the decentralized trading system of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a decentralized financial system that enables users to grow wealth without relying on traditional banks. There is a long-felt need for a platform that enables users to deposit money, such as from their paychecks, and have that capital securely traded on their behalf. Further, there is a need in the art for a decentralized trading vault that integrates artificial intelligence (AI) to execute trades based on market conditions and user preferences. Additionally, there is a need for a user-centric system that provides transparency through a mobile application interface, enabling users to track profits, customize risk levels, and receive real-time trade notifications. Finally, there is a need for a platform that provides consistent daily profit generation, secure or electronic vault storage, and fully autonomous financial participation outside centralized banking infrastructures.

The present invention, in one exemplary embodiment, is a mobile application for decentralized cryptocurrency investment. The mobile application for decentralized cryptocurrency investment comprises a dashboard module configured to display portfolio performance, historical profits and losses, total crypto holdings, and enable adjustments to investment preferences, a notifications module is configured to display real-time alerts relating to trade execution, deposit confirmations, and market volatility, a risk profile interface is configured to enable a user to select one of a plurality of predefined risk levels, a paycheck deposit interface is configured to scan or upload a paycheck image for processing and transfer of funds into a secure trading vault, and a communication interface configured to securely transmit user data and receive system updates from a remote trading server over an encrypted network.

Reference will now be made in detail to the present preferred embodiments of the invention, examples of which are illustrated in the accompanying drawings. Wherever possible, the same reference numerals are used in the drawings and the description to refer to the same or like parts.

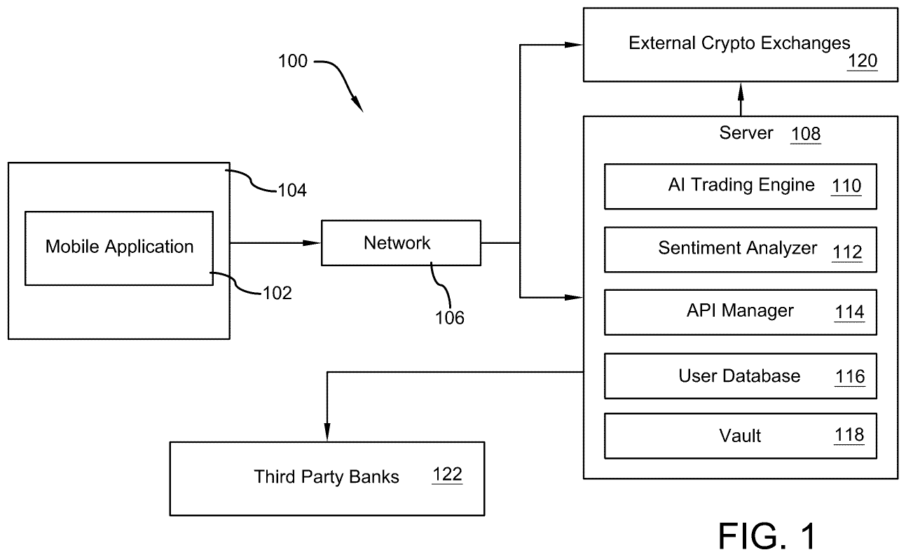

Referring initially to the drawings, FIG. 1 illustrates a system architecture diagram of decentralized cryptocurrency trading vault platform of the present invention in accordance with the disclosed structure. The decentralized cryptocurrency trading vault (i.e., electronic or digital) platform 100 of the present invention is designed to facilitate automated crypto trading to offer users a continuous income-generating platform outside of traditional banking systems. The decentralized cryptocurrency trading vault (i.e., electronic or digital) platform 100 is configured as a decentralized financial system and is not governed by traditional banks or the Federal Reserve. The decentralized cryptocurrency trading vault (i.e., electronic or digital) platform 100 includes a mobile application 102 operable on a user device 104. The user device 104 can be an electronic computing device such as a smartphone or tablet. The mobile application 102 enables users to interact with the decentralized cryptocurrency trading vault (i.e., electronic or digital) platform 100 and provides a plurality of user interfaces to create an account, scan and deposit paychecks, select risk profiles, monitor portfolio performance, and receive trade execution and profit notifications.

The mobile application 102 is communicatively coupled via a network 106 to a platform server 108. The network 106 can include the Internet, wireless communication protocols, or other distributed communication systems. The network 106 provides secure, bi-directional communication between the mobile application 102 and the server 108. It should be noted that the server 108 can be implemented as a cloud-based computing system or backend infrastructure configured to perform a plurality of automated trading and data processing functions offered by the decentralized cryptocurrency trading vault (i.e., electronic or digital) platform 100.

The platform server 108 includes a computational Artificial Intelligence (AI) trading engine 110 configured to execute cryptocurrency trades using machine learning (ML) algorithms. The AI Trading Engine 110 is configured to build and perform unique and customized trading strategies for each user based on the analysis of at least historical trading data, technical indicators, user-defined investment preferences, and market conditions. The AI trading engine 110 is trained on real-time and historical trading data across various cryptocurrencies from the global crypto markets.

A sentiment analyzer 112 is configured to analyze information and data received from external sources such as financial news feeds, crypto exchanges, economic indicators, and blockchain event trackers. Based on the analysis, the sentiment analyzer 112 produces sentiment scores or weighted market influence metrics which are provided to the AI trading engine 110 for training and enhancing predictive trade models for each user.

An API manager 114 included in the server 108 provides integration between the server 108 and one or more external crypto exchanges 120 or third party banks 122. The external crypto exchanges 120 can include third-party services such as Binance, Coinbase, Kraken, or other exchange platforms supporting APIs for real-time crypto asset trading. The API manager 114 configured to transfer funds between the external entities (exchanges and banks) and the decentralized cryptocurrency trading vault (i.e., electronic or digital) platform 100.

A user database 116 stores information of registered users of the platform 100. The information can include at least login credentials, personal information, risk profiles, deposit records, trading history, and preferences for automated trading for each user. Each user is uniquely identified in the user database 116 and the AI trading engine 110 may use information stored in the user database 116 for designing customized trading strategies for users. The user database 116 can be a distributed database, centralized database, relational, non-relational, object storage, or any other conventional storage means. Further, the user database 116 can include security features such as encryption, multi-factor authentication, and tamper-resistant logging to maintain the integrity and confidentiality of user information.

A secure or electronic vault 118 is designed to securely store capital of users and prevent unauthorized access. Unlike traditional banking systems that engage in fractional reserve lending, the secure or electronic vault 118 holds or retains user-deposited funds in segregated and secure accounts. The secure or electronic vault 118 permits continuous use of the deposited capital for trading operations, while preventing unauthorized access or capital erosion due to loan-based risk exposure. It should be noted that in the preferred embodiment, profits generated from crypto trading using the platform 100 are credited back into the user's savings or reinvestment pool (such as maintained in an external bank) without disturbing the initial capital unless explicitly withdrawn by the user.

In one embodiment, the communication between the mobile application 102, third-party banks 122, and the server 108 is conducted over encrypted protocols such as HTTPS, TLS, or blockchain-secured channels. Further, the decentralized cryptocurrency trading vault (i.e., electronic or digital) platform 100 preferably operates in a decentralized manner such that the user funds, trading activities, and reinvestments are not subject to centralized banking rules or federal reserve oversight.

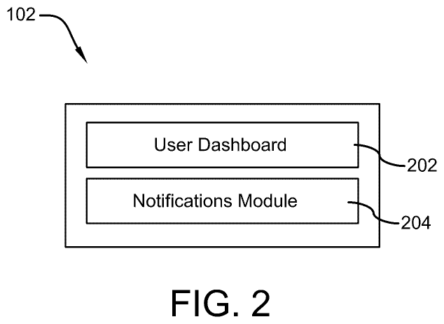

FIG. 2 illustrates a component-level diagram showing the modules included in the mobile application used in the decentralized cryptocurrency trading vault platform of the present invention in accordance with the disclosed structure. As illustrated, the mobile application 102 comprises a user dashboard module 202 which is configured to provide a plurality of user interfaces enabling users to interact with the platform 100. The user dashboard module 202 is also configured to provide graphical representation of a user's portfolio performance, including total crypto holdings, fiat value, historical profit/loss charts, and reinvestment summaries. The module 202 may also provide controls for setting or adjusting investment risk preferences, viewing historical trade logs, and toggling trading automation features.

The mobile application 102 further includes a notifications module 204, configured to generate and display alerts and status updates in real-time. The notifications module 204 may communicate updates such as completed trades, profit crediting events, market condition alerts, system status messages, deposit confirmations, and warnings regarding trading risks or market volatility. Notifications may be delivered via in-app alerts, push notifications, email, or SMS, depending on user configuration. The mobile application 102 may also include additional modules such as identity verification and biometric security, without departing from the scope of the invention.

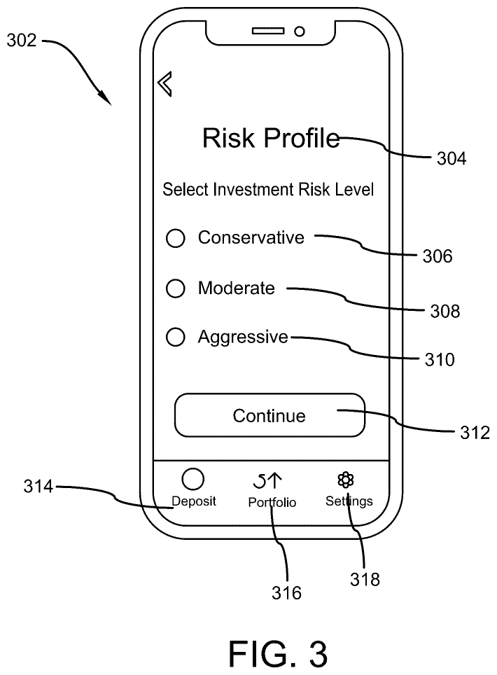

FIG. 3 illustrates an exemplary risk profile user interface displayed by the mobile application in accordance with one embodiment of the present invention. The user interface 302 illustrates an exemplary risk profile selection screen and is rendered on the user device 104. The screen includes a risk profile heading 304, which may be labeled “Risk Profile” or similar, indicating the functional purpose of the interface.

The user interface 302 displays a plurality of selectable risk profile options including a conservative risk level option 306, a moderate risk level option 308, and an aggressive risk level option 310. Each option has an associated selector for selecting the corresponding risk level. In use, a user can select any one of the risk profile options and apply using the continue button 312. Accordingly, the selected risk profile dynamically influences the AI trading engine's aggressiveness, asset class allocation, leverage utilization, and rebalancing frequency for the user.

The user interface 302 also displays a deposit tab 314, which links the user to interfaces for paycheck scanning and funding the secure or electronic vault as described later in the disclosure. A portfolio tab 316 opens the portfolio dashboard for the user to display current holdings and trade performances. A settings tab 318 enables the user to manage preferences, notifications, account security, and system configurations.

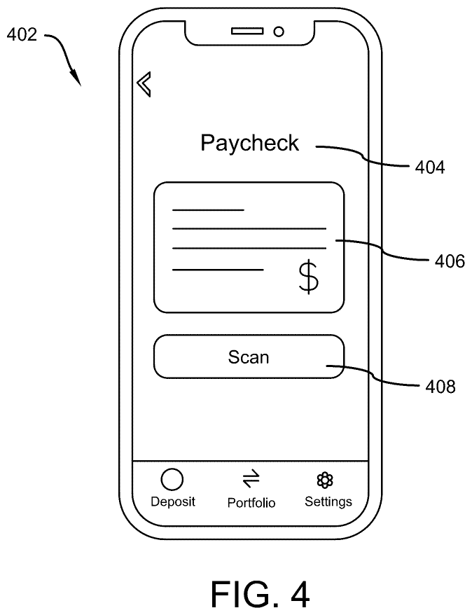

FIG. 4 illustrates a graphical user interface for a paycheck deposit for enabling users to initiate fiat funding of their trading account in accordance with the disclosed architecture. The interface 402 displays a heading label 404 displaying the term “Paycheck” or similar indicator to indicate purpose of the user interface 402. The interface 402 displays a check imaging region 406, which graphically represents a paycheck or check image placeholder and may also present a live camera viewfinder or an upload interface that enables users to capture an image of a paycheck or upload an electronic check image for processing.

A scan button 408 triggers a camera or file access process within the mobile device 104 to acquire a paycheck image. The image data is processed locally at the device 104 or at the platform server 108 to extract relevant information such as payer name, account number, routing number, amount, and endorsement information, which may be used for initiating a deposit transaction into the electronic or digital vault 118 or linked third-party bank.

In some embodiments, the interface 402 can include validation protocols, optical character recognition (OCR), fraud detection checks, and integration with third-party payment processing networks or banking APIs.

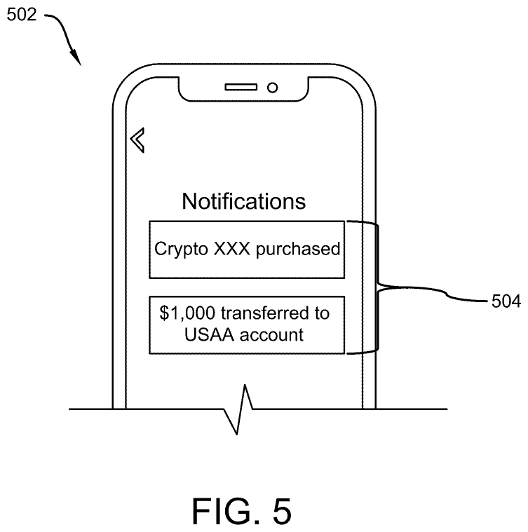

FIG. 5 illustrates a notification graphical user interface of the mobile application that enables users to receive real-time alerts and system-generated messages in accordance with one embodiment of the present invention. The notifications interface 502 is configured to display system alerts, confirmations, and status updates relating to the user's trading activity, account transactions, and portfolio changes. In the illustrated embodiment, a notifications panel 504 is displayed containing example messages such as “Crypto XXX purchased,” indicating that an automated or user-triggered crypto trade has successfully been executed on the platform 100. Another notification “$1,000 transferred to USAA account,” indicates a withdrawal transaction to a user-linked external bank account.

The notifications panel 504 can include timestamps, icons, priority flags, or interactive elements enabling users to tap or swipe for more details, dismiss notices, or configure alert preferences. In some embodiments, the mobile application 502 may enable users to filter notifications by type (e.g., trade-related, deposit-related, alert-based), or configure delivery settings (e.g., push notifications, email alerts, in-app badges).

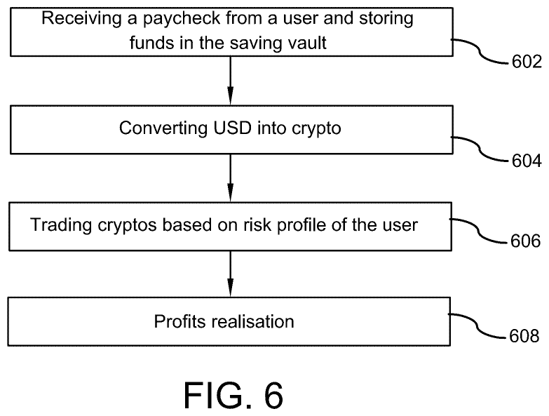

FIG. 6 illustrates a flowchart depicting an exemplary process flow for automating cryptocurrency trading and profit realization using the decentralized cryptocurrency trading vault platform of the present invention. In step 602, the platform initiates the process by receiving a paycheck from a user and storing funds in a saving vault. The paycheck may be scanned via the mobile application interface as shown in FIG. 4 or transmitted through direct deposit. Upon receipt, the funds are stored securely in the vault 118 (FIG. 1), which is configured to protect the principal without engaging in fractional lending practices.

In step 604, the stored USD is converted into cryptocurrency. The conversion may be performed via integrated exchange services through the API Manager 114 (FIG. 1), selecting optimal pricing from external crypto exchanges 120 (FIG. 1). The converted crypto assets are deposited into a digital wallet managed by the backend server.

In step 606, the platform 100 begins trading cryptocurrencies based on the user's selected risk profile. The AI trading engine 110 uses the risk configuration of the user as described in FIG. 3. The AI engine 110, in conjunction with the sentiment analyzer 112, dynamically executes trading strategies using real-time and historical market data.

In step 608, profits generated from successful crypto trades are calculated and can be converted back into fiat currency. The profits may be credited to the user's vault or savings pool for reinvestment or withdrawal. In the preferred embodiment, the original principal remains available for trading unless explicitly withdrawn by the user.

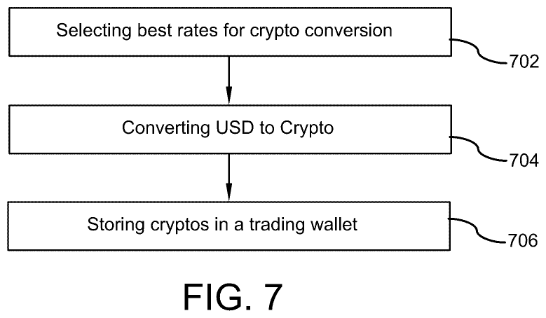

FIG. 7 illustrates a flowchart depicting a detailed sub-process of fiat-to-crypto conversion in the decentralized trading system of the present invention. In step 702, the best available exchange rates for crypto conversion are determined. The determination step can be handled by the API Manager 114 (FIG. 1), which may query a plurality of external cryptocurrency exchanges 120 (FIG. 1) to retrieve live exchange rates. The platform 100 may also consider additional parameters such as transaction fees, latency, and exchange reliability when determining the optimal rate.

In step 704, the platform 100 initiates conversion of USD into cryptocurrency using the selected rate and exchange. The amount of cryptocurrency acquired corresponds to the user's deposited USD value minus and excludes transaction or processing fees.

In step 706, the acquired cryptocurrency is securely stored in a trading wallet managed by the server 108. The wallet is independent and separate from the user's savings vault and is specifically designated for active trading operations executed by the AI trading engine 110.

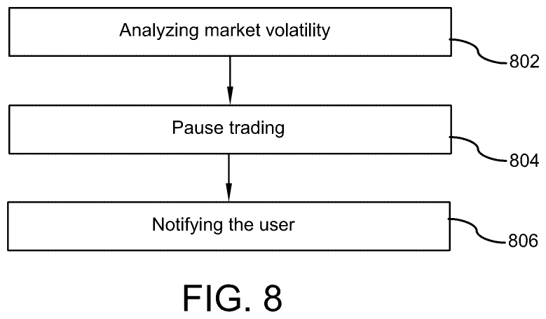

FIG. 8 illustrates a flowchart illustrating an exemplary emergency trading control process implemented by the decentralized trading system of the present invention in accordance with the disclosed architecture. In step 802, the platform 100 initiates analysis of market volatility. Specifically, the AI trading engine 110 and sentiment analyzer 112 (FIG. 1) collect and process real-time market data including price fluctuations, trading volume spikes, news events, and sentiment scores across crypto markets. The AI trading engine 110 evaluates if the current volatility exceeds a predefined risk threshold associated with the user's selected investment profile.

If the threshold is breached, the process proceeds to step 804, where the AI trading engine 110 automatically pauses trading operations. The automatically pause can include halting all open trade orders, suspending further buy/sell activity, and optionally converting volatile holdings into more stable digital assets or fiat equivalents to preserve capital.

In step 806, a notification is generated through the mobile application (as illustrated in FIG. 5) to inform the user of the market risk and the protective action taken by the platform. Notifications may be sent in real time via in-app alert, push notification, email, or SMS, depending on user settings.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “decentralized artificial intelligence-driven cryptocurrency trading vault platform”, “decentralized cryptocurrency trading vault system”, “decentralized cryptocurrency trading vault platform”, and “platform” are interchangeable and refer to the artificial intelligence-driven cryptocurrency trading platform 100 of the present invention.

Notwithstanding the foregoing, the artificial intelligence-driven cryptocurrency trading vault (i.e., electronic or digital) platform 100 of the present invention can be of any suitable configuration as is known in the art without affecting the overall concept of the invention, provided that it accomplishes the above stated objectives. One of ordinary skill in the art will appreciate that the artificial intelligence-driven cryptocurrency trading platform 100 as shown in the FIGS. are for illustrative purposes only, and that many other configurations of the artificial intelligence-driven cryptocurrency trading vault (i.e., electronic or digital) platform 100 are well within the scope of the present disclosure.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A decentralized cryptocurrency trading vault platform comprising:
a mobile application;
a user interface;
an electronic computing device;
a network;
a platform server; and
a user;
wherein said mobile application connects users to said decentralized cryptocurrency trading vault platform;
wherein said user interface having interfaces selected from the group consisting of create an account, scan a paycheck, deposit a paycheck, select a risk profile, monitor a portfolio performance, receive a trade execution, and receive a profit notification;
wherein said mobile application communicatively coupled with said network to said platform server;
wherein said network selected from the group consisting of an Internet, a wireless communication protocol, and a distributed communication system;
wherein said network provides bi-directional communication between said mobile application and said platform server;
wherein said platform server comprising a computational Artificial Intelligence (AI) trading engine configured to execute cryptocurrency trades using machine learning (ML) algorithms;
wherein said AI trading engine is configured to perform customized trading strategies for said user; and
further wherein said customized trading strategies selected from the group consisting of one or more of historical trading data, technical indicators, user-defined investment preferences, and market conditions.

2. The decentralized cryptocurrency trading vault platform of claim 1, wherein said AI trading engine is trained on real-time trading data and historical trading data of cryptocurrencies from global crypto markets.

3. The decentralized cryptocurrency trading vault platform of claim 2 further comprising a sentiment analyzer configured to analyze data received from external sources selected from the group consisting of financial news feeds, crypto exchanges, economic indicators, and blockchain event trackers.

4. The decentralized cryptocurrency trading vault platform of claim 3, wherein said sentiment analyzer produces sentiment scores and provides said sentiment scores to said AI trading engine for training predictive trade models for said user.

5. The decentralized cryptocurrency trading vault platform of claim 4, wherein said server having an API manager connected to one or more external crypto exchanges selected from the group consisting of Binance, Coinbase, and Kraken.

6. The decentralized cryptocurrency trading vault platform of claim 5, wherein said API manager is configured to transfer funds between said external crypto exchanges and said decentralized cryptocurrency trading vault platform.

7. The decentralized cryptocurrency trading vault platform of claim 6 further comprising a user database to store user information of said user of said decentralized cryptocurrency trading vault platform, wherein said user information selected from one or more of the group consisting of login credentials, personal information, said risk profile, deposit records, trading history, and preferences for automated trading for said user.

8. The decentralized cryptocurrency trading vault platform of claim 7, wherein said user having a unique identifier in said user database and said AI trading engine using said user information stored in said user database to recall said customized trading strategies for said user.

9. The decentralized cryptocurrency trading vault platform of claim 7 further comprising an electronic vault to store user-deposited funds of said user, wherein said electronic vault retains said user-deposited funds in a plurality of segregated accounts.

10. The decentralized cryptocurrency trading vault platform of claim 9, wherein said electronic vault permits continuous use of said user-deposited funds for said cryptocurrency trades to generate profits.

11. The decentralized cryptocurrency trading vault platform of claim 10, wherein said profits from said cryptocurrency trades are credited back into a designated account of said user selected from the group consisting of a savings account and a reinvestment pool.

12. The decentralized cryptocurrency trading vault platform of claim 11, wherein said mobile application having a user dashboard module configured to provide a plurality of said user interfaces selected from the group consisting of a graphical representation of a user's portfolio performance, total crypto holdings, a fiat value, a historical profit and loss chart, and a reinvestment summary.

13. The decentralized cryptocurrency trading vault platform of claim 12, wherein said user dashboard module having controls for setting one or more of the group consisting of an investment risk preference, a view of historical trade log, and a toggle of trading automation.

14. A decentralized cryptocurrency trading vault platform comprising:
a mobile application;
a user interface;
an electronic computing device;
a network;
an electronic vault;
a platform server; and
a user;
wherein said mobile application connects users to said decentralized cryptocurrency trading vault platform;
wherein said user interface having interfaces selected from the group consisting of create an account, scan a paycheck, deposit a paycheck, select a risk profile, monitor a portfolio performance, receive a trade execution, and receive a profit notification;
wherein said mobile application communicatively coupled with said network to said platform server;
wherein said network selected from the group consisting of an Internet, a wireless communication protocol, and a distributed communication system;
wherein said network provides bi-directional communication between said mobile application and said platform server;
wherein said platform server configured to execute cryptocurrency trades using machine learning (ML) algorithms;
wherein said cryptocurrency trades are configured to perform customized trading strategies for said user;
wherein said customized trading strategies selected from the group consisting of one or more of historical trading data, technical indicators, user-defined investment preferences, and market conditions;
wherein said server having an API manager connected to one or more external crypto exchanges selected from the group consisting of Binance, Coinbase, and Kraken;
wherein said API manager is configured to transfer funds between said external crypto exchanges and said decentralized cryptocurrency trading vault platform;
wherein said user having a unique identifier in said user database using said user information stored in said user database to recall said customized trading strategies for said user;
wherein said electronic vault stores user-deposited funds of said user;
wherein said electronic vault retains said user-deposited funds in a plurality of segregated accounts; and
further wherein said electronic vault permits continuous use of said user-deposited funds for said cryptocurrency trades to generate profits.

15. The decentralized cryptocurrency trading vault platform of claim 14, wherein said profits from said cryptocurrency trades are credited back into a designated account of said user selected from the group consisting of a savings account and a reinvestment pool.

16. The decentralized cryptocurrency trading vault platform of claim 15, wherein said mobile application having a notification module configured to generate an alert in real-time, wherein said alert is an update selected from the group consisting of completed trades, profit crediting events, market condition alerts, system status messages, deposit confirmations, warnings regarding trading risks, and warnings regarding market volatility.

17. The decentralized cryptocurrency trading vault platform of claim 16, wherein said risk profile having a profile option selected from the group consisting of a conservative risk level option, a moderate risk level option, and an aggressive risk level option, and further wherein another said profile option selected from the group consisting of an asset class allocation, a leverage utilization, and a rebalancing frequency for said user.

18. A method of trading cryptocurrency in a decentralized cryptocurrency trading vault platform, the method comprising the steps of:
providing a decentralized cryptocurrency trading vault platform having a mobile application, a user interface, an electronic computing device, a network, an electronic vault, a platform server, and a user;
connecting said mobile application of said user to said decentralized cryptocurrency trading vault platform, wherein said user interface having interfaces selected from the group consisting of create an account, scan a paycheck, deposit a paycheck, select a risk profile, monitor a portfolio performance, receive a trade execution, and receive a profit notification;
connecting said mobile application with said network to said platform server, wherein said network selected from the group consisting of an Internet, a wireless communication protocol, and a distributed communication system;
bi-directionally communicating with said network between said mobile application and said platform server;
performing customized trading strategies of said cryptocurrency trades for said user, wherein said customized trading strategies selected from the group consisting of one or more of historical trading data, technical indicators, user-defined investment preferences, and market conditions;
wherein said server having an API manager connected to one or more external crypto exchanges selected from the group consisting of Binance, Coinbase, and Kraken;
transferring funds with said API manager between said external crypto exchanges and said decentralized cryptocurrency trading vault platform;
recalling said customized trading strategies for said user using a unique identifier in said user database;
storing user-deposited funds of said user in said electronic vault, wherein said electronic vault retains said user-deposited funds in a plurality of segregated accounts; and
further wherein said electronic vault permits continuous use of said user-deposited funds for said cryptocurrency trades to generate profits.

19. The method of trading cryptocurrency in a decentralized cryptocurrency trading vault platform of claim 18, wherein said profits from said cryptocurrency trades are credited back into a designated account of said user selected from the group consisting of a savings account and a reinvestment pool.

20. The method of trading cryptocurrency in a decentralized cryptocurrency trading vault platform of claim 18, wherein said risk profile having a profile option selected from the group consisting of a conservative risk level option, a moderate risk level option, and an aggressive risk level option, and further wherein another said profile option selected from the group consisting of an asset class allocation, a leverage utilization, and a rebalancing frequency for said user.
